(19) United States
(12) Patent Application Publication
(10) Pub. No.: US 2009/0288020 A1
(43) Pub. Date: Nov. 19, 2009

(54) SYSTEM AND METHOD FOR COMMUNICATING ABOUT CHARITABLE DONATIONS

(76) Inventor: Amy Kathleen Morrison, Walla Walla, WA (US)

Correspondence Address: KOLISCH HARTWELL, P.C., 200 PACIFIC BUILDING, 520 SW YAMHILL STREET, PORTLAND, OR, 97204, US

(21) Appl. No.: 12/354,424

(22) Filed: Jan. 15, 2009

Related U.S. Application Data
(60) Provisional application No. 61/021,293, filed on Jan. 15, 2008.

(51) Int. Cl. G06F 3/01

(52) U.S. Cl. 715/760

(57) ABSTRACT

A system and method for communicating about charitable donations and the donation process can be utilized by multiple classes of donors such as individuals, businesses and nonprofit agency donors. The system includes a networking web site accessible via a local or global computer network that allows donors to streamline the donation process, and a communication mechanism, accessible via the web site, that allows users to manage their donations.

### CROSS-REFERENCE TO RELATED APPLICATIONS

This application claims priority to U.S. Provisional Patent Application Ser. No. 61/021,293, filed Jan. 15, 2008, and entitled “System and Method for Communicating About Charitable Donations”, the disclosure of which is incorporated herein by reference.

### FIELD OF THE DISCLOSURE

This disclosure generally relates to charitable donations. More particularly, this disclosure relates to a system and method for communicating about charitable donations and the donation process, and where the system and method can be utilized by multiple classes of donors such as individuals, businesses and nonprofit agency donors.

### SUMMARY OF THE DISCLOSURE

The disclosure includes a system and method for communicating about charitable donations and the donation process that can be utilized by multiple classes of donors such as individuals, businesses and nonprofit agency donors. That system and method could take the form of a networking web site accessible via a local or global computer network that allows donors to streamline the donation process. One aspect of the communication feature is to allow users to manage their donations.

The concept of making a donation should be understood in its broadest sense as making any type of gift to another. That gift may also be thought of as a grant or contribution.

A software-implemented system is presently proposed, but other implementations are within the scope of this disclosure.

In its software-implementation, the system and method take the form of a website, and Attachment A shows typical screens viewable by users. The system includes a mechanism for querying users to create and profile for themselves. There are multiple queries, and presently eight questions are asked of users to cause the system to make a user-specific profile. The user (i.e. donor) classifies themselves as an individual, business member or nonprofit agency member. By member, the system understands that the person is a representative of the business or nonprofit agency, and a profile is set up for that corresponding business or nonprofit agency.

In its web-based software implementation. the system and method (referred to collectively as “system” below) is community-driven where users communicate via a single website instead of having to download software to their individual computers. The system also provides two-way communication (about giving and receiving) through a network of businesses, individuals and nonprofit agencies. There is also online, real-time tracking of requests, and submitted gifts.

Through the software-implementation, the system and method also provide the functions of helping users plan, organize and perform follow up. With respect to planning, the system leads business members through a multi-step process of forming a giving philosophy. The system also leads nonprofit members through multiple guidelines for indentifying appropriate business alliances.

With respect to organizing, the system helps business members by compiling requests and scheduling pertinent meetings on a pre-selected schedule. The system also helps nonprofit members to be proactive as they implement a charitable donation plan. For example, the system allows those members to organize charitable requests well ahead of time and then to implement a schedule for timely completing those requests.

With respect to follow up communications and other activity, the system allows business members to input and track gifts through an online form that is automatically used by the system to create a year-end statement for the user. The system also allows nonprofit members to input gifts received, and the system automatically generates thank-you lists for corresponding thank-you communications to donors, and donor lists to allow the members to maintain a relationship with donors.

The system is designed to create a community of parties made up of individuals and organizations that interact with each other due to their interest in making donations. The system is also designed to be customizable for other applications that do not have to do with donations, if the community created by the system shows an interest in other areas, or if the system designer wants to make other areas/topics available to that community.

The disclosure set forth above encompasses distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the disclosure recites “a” or “a first” element or the equivalent thereof, such disclosure should be understood to include incorporation of one or more such elements, neither requiring nor excluding two or more such elements.

Novel and non-obvious combinations and subcombinations of features, functions, elements and/or properties may be claimed through presentation of claims in a related application.

I claim:

1. A system for communicating about charitable donations and the donation process that can be utilized by multiple classes of donors such as individuals, businesses and nonprofit agency donors, comprising:
a networking web site accessible via a local or global computer network that allows donors to streamline the donation process; and
a communication mechanism, accessible via the web site, that allows users to manage their donations.

2. A method for communicating about charitable donations and the donation process that can be utilized by multiple classes of donors such as individuals, businesses and nonprofit agency donors, comprising:
selecting a networking web site and making it accessible via a local or global computer network that allows donors to streamline the donation process; and
providing a communication mechanism, accessible via the web site, that allows users to manage their donations.
